(19) United States
(12) Patent Application Publication
(10) Pub. No.: US 2007/0176373 A1
(43) Pub. Date: Aug. 2, 2007

(54) Low stress / anti-buckling spiral wound gasket

(76) Inventors: Steven Suggs, Atlanta, GA (US); Reid Meyer, Newnan, GA (US); Steven Kristopher Kolb, Humble, TX (US)

Correspondence Address: BAKER, DONELSON, BEARMAN, CALDWELL & BERKOWITZ, SUITE 3100 SIX CONCOURSE PARKWAY, ATLANTA, GA, 30328, US

(21) Appl. No.: 11/341,110

(22) Filed: Jan. 28, 2006

(51) Int. Cl. F16J 15/02

(52) U.S. Cl. 277/633

(57) ABSTRACT

A spiral wound gasket (10) with increased resistance to an inward buckling while sealing flanges at low stress levels, in which an outer guide ring (14) for positioning the gasket within the bolt circle of a bolted flange connection connects to a sealing element (12) having a core (16) that contributes to gasket recovery and made of a spirally wound, chevron-shaped band overlaid by a layer (20) of sealing material covering at least a portion of opposing sides of the core to conformably seal contact faces of flanges to be sealed.

### TECHNICAL FIELD

The present invention relates to spiral wound gaskets for sealing between pipe flanges. More particularly, the present invention relates to spiral wound gaskets that effect seals at low stress loads while resisting buckling of seal material during loading.

### BACKGROUND OF THE INVENTION

Spiral wound gaskets are well known for sealing between pipe flanges in high pressure flange joint applications. Typically such gaskets consist of an outer guide ring that is used as a compression limiter. The spiral winding or sealing element includes alternating layers of a metal band and a suitable filler material wound upon itself to form a laminated structure that is resilient in a direction perpendicular to the plane of the spiral. The outer guide ring attaches usually with a groove to the outer periphery of the wound sealing element. The outer guide ring centers the gasket within the bolt circle of the bolted flange connection, prevents over-compression of the wound sealing element, and contributes to an increase in radial strength. The outer guide rings are usually formed from carbon steel. Spiral wound gaskets install between opposed flanges of mating pipe ends. The pipe flanges clamp together with circumferentially spaced bolts or other suitable fastening arrangement.

By design, a spiral wound gasket can be compressed from its original manufactured thickness down to the outer guide ring thickness. For known spiral wound gaskets today, the original manufactured thickness is about 0.175 inches and the outer guide ring thickness is 0.125 inches. The outer guide ring functions as a mechanical stop and prevents over-compression of the sealing element. As the spiral wound gasket is compressed two things occur. The filler material compresses and as discussed below, the outer ring may become dished. First, depending upon the compressibility of the filler material, the filler itself compresses such that there is an overall reduction in the volume of the gasket element. Once the filler compresses to its “absolute density” there can be no further reduction in the sealing element volume. Further compression merely displaces the fixed volume of the sealing element.

Three predominate filler materials used in spiral wound gaskets today are mica-graphite, flexible graphite and PTFE. While both the mica-graphite and flexible graphite are compressible and allow some volume reduction within the gasket while being compressed, sintered PTFE is essentially uncompressible. The compression of a spiral wound gasket with sintered PTFE results mostly in a displacement of the original volume. However, due to the lack of control that exists with conventional gasket winding equipment, the potential compressibility that exists with the graphite filler materials is significantly reduced as the gasket is being produced. This results in the gasket being essentially incompressible even before installation in a flange.

To enhance the mechanical reliability and sealing performance of gaskets today, gaskets are installed using much higher bolt loads than were typically used in the past. These higher bolt loads overcome the resistance of the fully compressed filler/gasket element and force volume displacement as the gasket is compressed down to the thickness of the outer retaining ring. The increased loading and volume displacement can result in the gasket imploding at the inside diameter. This problem is referred to as inner buckling.

Inner buckling lends to substantial problems. First, inner buckling causes a loss of bolt load because of the stress relief that has occurred. Second, a protrusion of the gasket into the pipe bore not only creates turbulent flow, but the protrusion is also likely to break the gasket. A broken gasket may “unwind” into the flow stream and ultimately cause a total loss of seal. Further, objects called “pipe pigs” often are shot through pipes to clear scale or clogs. A pipe pig passing by a buckled gasket can break the gasket and cause the gasket to unwind and the seal to fail.

To prevent inner buckling, spiral wound gaskets include a separate inner retaining ring. Inner rings have become a requirement in national standards (ASME B16.20) on many sizes and filler styles of spiral wound gaskets to aid in resisting the distortion of the gasket in the radially inward direction. For instance, all spiral wound gaskets having PTFE as a filler material are required to have an inner ring. It is now recognized, however, that the inner ring does not prevent inward buckling. While inner rings impede the displacement or flow of the gasket into the inside diameter of the pipe, inner rings are physically unable to completely prevent this inward flow because of their narrow cross section. The inside diameter of the gasket remains as the weakest plane. Unfortunately, inner rings add considerably to the cost of the spiral wound gasket. These increased costs result from the cost of the metal itself (typically a stainless steel or exotic alloy), machining costs, labor costs to install it and finally the cost of inventorying a separate line item. Also, the fit of the inner ring within the spiral wound gasket inside diameter is often variable. Often times the inner ring falls out from the gasket during handling or shipping and that creates in persons seeking to seal flanges a sense of unreliability as to the gasket.

Another phenomena during compression is known as “dishing” of the outer guide ring. Dishing occurs when there are extreme radial forces developed during compression. The normally flat outer guide ring becomes dished, or forced into a convex or concave shape. As the ring becomes dished, still higher bolt loads must be exerted render the outer guide ring flat again so that the outer guide ring performs as a true compression stop.

As discussed above, buckling is a phenomena associated with compressible filler materials contained within the wound sealing element of traditional spiral wound gasket designs. However, buckling is necessary to establish a conformable seal within a bolted connection. The seal, however, is considered inferior to that of softer sealing elements that by nature are more conformable to flange irregularities and fill imperfections.

Expanded flexible graphite by nature is a soft conformable material that is considered one of the most advanced sealing elements due to its chemical inertness and ability to withstand elevated temperatures. When compressed or molded under high pressure, the porosity is extremely low, creating an excellent seal for applications requiring low fugitive emissions or leakage that permeates through the seal. Molded flexible graphite formed into a gasket shape, while highly conformable, lacks the rigidity or recovery associated with the spiral wound design.

Accordingly, there is a need in the art for a flange sealing gasket with the recovery performance of spiral would gaskets while providing a sealing surface readily conformable to flange irregularities. It is to such that the present invention is directed.

### SUMMARY OF THE PRESENT INVENTION

The present invention meets the need in the art by providing a spiral wound gasket having a resilient core comprising an elongate band spirally wrapped with overlying turns having at least portions of adjacent turns in contacting relation and an outer guide ring mounted to an outer periphery of the resilient core. An intercalated graphite overlay covering at least a portion of opposing faces of the resilient core effects conforming seals of flanged pipe connections.

Objects, features, and advantages of the present invention will become apparent from a reading of the following detailed description of the invention and claims in view of the appended drawings.

### BRIEF DESCRIPTION OF THE DRAWINGS

FIG. 1 illustrates in perspective, cutaway view a low stress, anti-buckling spiral wound gasket according to the present invention.

FIG. 2 illustrates in exploded perspective view a second embodiment of the spiral wound gasket according to the present invention.

FIG. 3 illustrates in perspective cut-away view a low stress, anti-buckling spiral wound gasket with a sealing overlay of radially varying density and depth.

FIG. 4 illustrates in perspective cutaway view a third embodiment of the spiral wound gasket according to the present invention.

### DETAILED DESCRIPTION

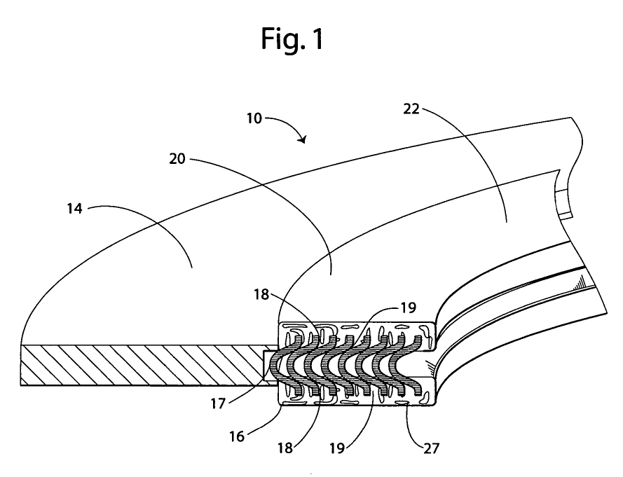

With reference to the drawings, in which like parts have like identifiers, FIG. 1 illustrates in perspective partial view a spiral wound gasket 10 having a spiral winding or sealing element 12. An outer guide ring 14 attaches to a radially exterior edge of the sealing element 12. The sealing element 12 includes a resilient spiral core 16 made with an elongate metal band wound into a spiral of overlying turns or layers. A portion of the inner winding and the adjacent winding of the band are fixed together such as by welding. A portion of the outer winding is similarly fixed to the adjacent radially inward winding. In the illustrated embodiment, the elongate band is chevron shaped in cross-sectional view, such as with a crimp or medial projection 17 defining a ridge in the band between opposing sides 18. The projection 17 defines a tapering surface to the sides 18. The spiral winding of the band brings adjacent turns into contacting relation at contact points, for example, intermediate an apex of the projection 17 and the sides 18. The points of contact between adjacent turns defines a gap 19 between the adjacent sides in the turns. The gap 19 is open to the contact of the sloping sides of the projections 17. The resulting spiral windings accordingly nest together to form a resilient ring or core 16 for the sealing element 12. The core 16 lacks a resilient fill material extending through the core in alternate overlapping relation with the band.

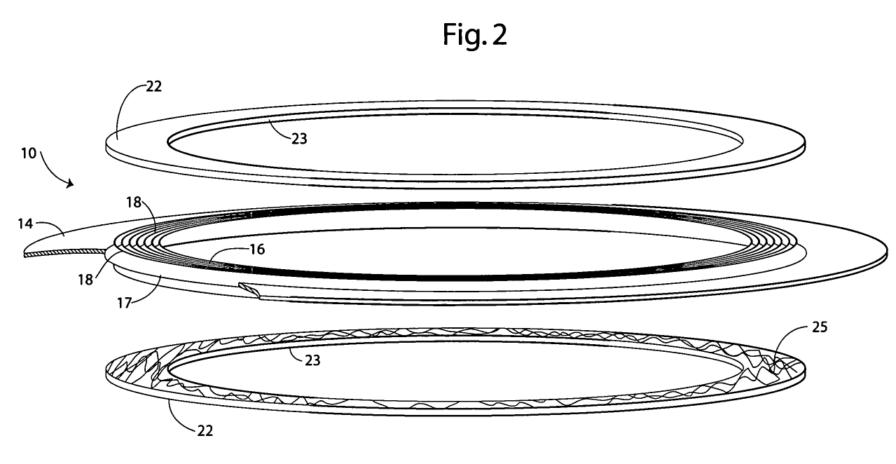

The sealing element 12 further includes a conformable sealing material overlay 20 that provides a conformable sealing surface 22 for bearing contact with the face of the flange to be sealed. The overlay 20 covers at least a portion of the core 16. The sealing material overlay 20 in a first embodiment illustrated in exploded perspective view in FIG. 2 comprises a pair of annular rings 23 cut from a compressed sheet. Compressed sheets of sealing material useful in the present invention include calendared intercalated graphite, such as GRAFOIL sheet available from Graftech, Inc. of Lakewood, Ohio. Other compressed sheets such as those made with aramid fiber sheets, mineral fillers, fibers jacketed in rubber suspensions, and similar such compressed sheets, may be used.

Each of the annular rings 23 is sized with an inner diameter and an outer diameter for being received on the core 16 of the sealing element 12. The rings attach to the opposing faces of the core. The rings 23 attach mechanically by being pressed into place and engaging the edges 18 of the metallic band forming the core 16. The sides 18 enter into the ring and portions of the sealing material fills the gaps 19 between adjacent sides 18. In alternate embodiments, the rings also attach with an adhesive 25 (illustrated on one of the rings 23 in FIG. 2.) The adhesive is applied either to the ring or to the opposing surfaces of the core 16.

In another embodiment illustrated in FIG. 1, the overlay 20 comprises a plurality of expanded intercalated graphite vermiform 27. Particles of expanded intercalated graphite vermiform have elongate structures and are extremely light and puffy. A significantly large volume of the vermiform is required to produce a relatively thin compressed layer of sealing material. There is an approximate 100-to-1 ratio between the volume of expanded vermiform and compressed vermiform.

In this embodiment, the opposing overlay 20 are formed in a mold. A plurality of the intercalated graphite vermiform communicate into a first cavity of the mold. An intermediate gasket assembly made of the core 16 and the outer ring 14 is placed in the mold. Additional intercalated graphite vermiform communicate into the mold on the opposing side. The mold is then operated in order to compress the intercalated graphite vermiform together and sandwich the core 16. The overlay 20 is thereby molded at a first density but has remaining capacity to compress further during installation to a second density greater then the first density.

The molded overlay 20 mechanically engage the sides 18 with a portion of the intercalated graphite vermiform filling the gaps 19. The resilient material of the sealing element accordingly only partially fills the interstices between adjacent turns of the core 16. The spiral core 16 has contacts between adjacent turns of the elongate band. The resilient seal material does not extend transversely through the core 16 between the opposing faces defined by the edges of the sides 18 of the band.

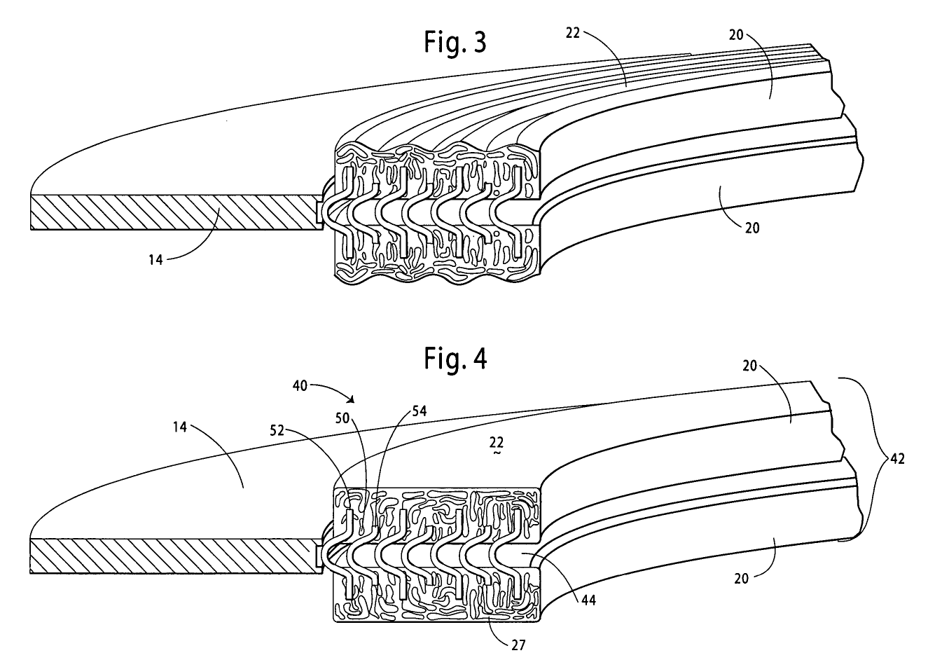

The overlay 20 provided in sheet form as a ring (FIG. 2) has substantially uniform thickness and density. The second embodiment of molding the overlay 20 in place with the intercalated graphite vermiform (FIG. 1) enables the resulting spiral wound gasket to have multiple thicknesses and densities through the overlay 20. This is controlled by machining different clearances in the mold. For example, it may be desired that the sealing surface 22 have a corrugated surface as illustrated in FIG. 3.

FIG. 4 illustrates in perspective a partial cut-away view of a spiral wound gasket 40 as a third embodiment of the low stress, anti-buckling spiral wound gasket according to the present invention. The gasket 40 having a spiral sealing element 42 with an outer guide ring 14 attached to a radially exterior edge. In this embodiment, the sealing element 42 includes a resilient spiral core 44 made with a first elongate metal band 46 and a second elongate metal band 48 wound into a spiral of overlying turns in alternation relation of the first and second metal bands 46, 48. The winding of the first and second bands 46, 48 have points of contact between the adjacent turns which define gaps generally 50 between adjacent sides 52, 54 of the bands 46, 48, respectively. In this embodiment, the first metal band 46 is a width exceeding that of the second metal band 48. Accordingly, the side portion of the first metal band extends deeper into the overlay 20 then does the side of the adjacent turn of the second metal band 48. The effective unit load on the turns of the first metal band is increased over a gasket in which the sides extend equally into the overlay 20.

The thickness of the bands 46, 48 can be the same or can differ. In the illustrated embodiment, the thickness of the first band 46 is less than the thickness of the second band 48. The thickness of the bands used for the core 16 and core 44 are typically about 0.007 inches; however, the thickness of the band ranges from about 0.005 inches to about 0.0125 inches thick. The width of the band is typically about 0.150 inches, although the width can range between about 0.125 inches to about 0.200 inches. Metal is preferred for the bands as providing a hard dense and non-compressible material for forming the spiral core.

A gasket made in accordance with the present invention was subjected to stress load testing to evaluate inner buckling. The test gasket was a 10-inch, Class 150 spiral wound gasket having an overlay 20 made by molding a plurality of intercalated graphite vermiform 27 as discussed above. For comparison purposes, a LEADER standard spiral wound gasket meeting ASME standard B16.20 was also tested. This gasket had sheet graphite filler material between the turns in the spiral core and as the overlay. The test evaluated the inner buckling of the gaskets after loading the bolts to three stress levels by measuring the deflection (in inches) at the bolt locations.

It was observed that the LEADER gasket experienced inner buckling occurred at several locations. In contrast, no buckling was measured or observed for the test gasket made in accordance with the present invention.

In addition to reduced or eliminated inner buckling, the present invention provides improved sealability during cycling of stress loads, based on tests that included a corrugated metal gasket with graphite jacketing layer, a LEADER standard spiral wound gasket, and other commercially available spiral wound gaskets. The corrugated metal gasket with graphite jacketing layer was tested because this product has been found to have superior recovery and sealing capability during gasket stress load cycles. Leakage from the seated flange connection was measured at the maximum psi load and at the minimum psi load in five cycles. The low-stress anti-buckling spiral wound gasket of the present invention had performance comparable to the corrugated metal gasket with graphite jacketing. The spiral wound gasket of the present invention had recovery performance superior to the other spiral wound gaskets in the tests.

The present invention accordingly combines the rigidity and recovery advantages of spiral wound gaskets with the conformability of soft sealing materials. The layer of flexible graphite over the outer faces of the spiral wound gasket sealing element (rather than layering them alternately with a filler or sealing material), creates a superior seal by eliminating the issues of non-conformity that is characteristic of traditional spiral wound gasket technologies. The layer of flexible graphite is extremely non-porous and creates a seal that has very low permeability. Eliminating the filler materials and winding only the band to form the core of the sealing element, greatly reduces or eliminates the possibility of inward buckling. The absence of a compressible sealing material that is subject to shifting prevents an extreme deformation of the sealing element or inward buckling. The volume reduction is consumed by the void or area between the two overlay 20 layers of sealing material.

The present invention accordingly provides an apparatus and method for forming improved spiral wound gaskets. The principles, preferred embodiments, and modes of operation of the present invention have been described in the foregoing specification. The invention is not to be construed as limited to the particular forms disclosed because these are regarded as illustrative rather than restrictive. Moreover, variations and changes may be made by those skilled in the art without departure from the spirit of the invention as described by the following claims.

What is claimed is:

1. A spiral wound gasket comprising:
a resilient core comprising an elongate band spirally wrapped with overlying turns having at least portions of adjacent turns in contacting relation;
an outer guide ring mounted to an outer periphery of the resilient core; and
an overlay of a sealing material covering at least a portion of opposing faces of the core for effecting conforming seals of flanged pipe connections.

2. The spiral wound gasket as recited in claim 1, wherein the sealing material comprises intercalated graphite.

3. The spiral wound gasket is recited in claim 1, wherein the overlay has a uniform thickness and a uniform density.

4. The spiral wound gasket as recited in claim 1, wherein the overlay has radially varying thickness and densities.

5. The spiral wound gasket as recited in claim 1, wherein the overlay comprises an annular ring cut from a calendared sheet.

6. The spiral wound gasket as recited in claim 5, wherein the calendared sheet comprises intercalated graphite.

7. The spiral wound gasket as recited in claim 1, wherein the sealing material comprises a plurality of intercalated graphite vermiform compressed together about the core to define the overlay.

8. The spiral wound gasket as recited in claim 1, wherein the overlay attaches mechanically to edge portions of the core.

9. The spiral wound gasket as recited in claim 1, further comprising an adhesive to bond the overlay to the core.

10. The spiral wound gasket as recited in claim 1, further comprising a second elongate band spirally wrapped in adjacent relation to the elongate band with overlying turns of the adjacent elongate band and second elongate band having at least portions in contacting relation.

11. The spiral wound gasket as recited in claim 10, wherein the elongate band has a first width and a first thickness and the second elongate band has a second width and a second thickness.

12. The spiral wound gasket as recited in claim 11, wherein the first thickness is greater than the second thickness.

13. The spiral wound gasket as recited in claim 11, wherein the first width is greater than the second width.

14. A spiral wound gasket for sealing flanged pipe connections, comprising:
a core made of an elongate band spirally wrapped with overlying turns to define opposing faces and secured at respective portions of an inner diameter and an outer diameter, the band having a projecting portion intermediate opposing lateral sides, whereby the spiral defines contact surfaces between adjacent turns;
an outer guide ring attached to an outer periphery of the core; and
an overlay of a sealing material covering at least a portion of the opposing faces of the core, the sealing material overlay mechanically engaged to the sides.

15. The spiral wound gasket as recited in claim 14 wherein the core defines a gap between adjacent sides in the turns, the gap open to a point of contact between adjacent turns, which gap receives portions of the sealing material in the overlay.

16. The spiral wound gasket as recited in claim 14, wherein the sealing material comprises calendared sheet.

17. The spiral wound gasket is recited in claim 16, wherein the calendared sheet comprises intercalated graphite.

18. The spiral wound gasket as recited in claim 16, wherein the sealing material overlay comprises intercalated graphite vermiform molded in place to a first density to form the overlay.

19. The spiral wound gasket as recited in claim 14, wherein the overlay has a uniform thickness and a uniform density.

20. The spiral wound gasket as recited in claim 14, wherein the overlay has radially varying thicknesses and densities.

21. The spiral wound gasket as recited in claim 14, wherein the overlay comprises an annular ring cut from a calendared sheet of intercalated graphite.

22. The spiral wound gasket as recited in claim 14, wherein the sealing material comprises a plurality of intercalated graphite vermiform compressed together by a mold about the core to define the overlay.

23. The spiral wound gasket as recited in claim 14, wherein the overlay attaches mechanically to edge portions of the core.

24. The spiral wound gasket as recited in claim 14, further comprising an adhesive to bond the to the core.

25. The spiral wound gasket as recited in claim 14, further comprising a second elongate band spirally wrapped in adjacent relation to the elongate band with overlying turns of the adjacent elongate band and second elongate band having at least portions in contacting relation.

26. The spiral wound gasket as recited in claim 25, wherein the elongate band has a first width and a first thickness and the second elongate band has a second width and a second thickness.

27. The spiral wound gasket as recited in claim 26, wherein the first thickness is greater than the second thickness.

28. The spiral wound gasket as recited in claim 26, wherein the first width is greater than the second width.

29. A spiral wound gasket that seals with low flange loading and having reduced susceptibility to inward buckling, comprising:
multiple windings of metallic filler to define a spiral sealing element, an outer guide ring mounted to an outer periphery of said sealing element; and
an overlay of flexible graphite applied to at least a portion of the opposing outer surfaces of the said sealing element.
